(19) United States
(12) Patent Application Publication
(10) Pub. No.: US 2017/0353492 A1
(43) Pub. Date: Dec. 7, 2017

(54) IN-BAND ASYMMETRIC PROTOCOL SIMULATOR

(71) Applicant: FORMALTECH, INC., Portland, OR (US)

(72) Inventors: Adam Cogen Wick, Portland, OR (US); Charles N. Kawasaki, Portland, OR (US); Trevor Simon Elliott, Portland, OR (US); Nathan Collins, Portland, OR (US); Eugene Rogan Creswick, Portland, OR (US)

(21) Appl. No.: 15/613,001

(22) Filed: Jun. 2, 2017

Related U.S. Application Data
(60) Provisional application No. 62/347,016, filed on Jun. 7, 2016.

(51) Int. Cl. H04L 29/06; H04L 12/24; H04L 12/26

(52) U.S. Cl. CPC H04L 63/1491; H04L 43/0876; H04L 41/145; H04L 41/0853; H04L 63/1425; H04L 63/1441

(57) ABSTRACT

A method for emulating devices communicating over one or more networks includes intercepting and recording protocols used in communications between real network devices and statistically analyzing the recorded protocols. The method further includes developing, based on the statistical analysis, a behavioral specification for at least one master honeypot. In some examples, the development of the behavioral specification includes generating a Markov chain based on the statistical analysis, which is used to guide the probabilistic selection of properties of packets to be sent from the at least one master honeypot to at least one remote monkey honeypot. Each packet includes an unencrypted header and an encrypted payload, and each encrypted payload includes a response specification to be executed by the at least one remote monkey honeypot upon receipt of the packet from the at least one master honeypot.

### CROSS-REFERENCE TO RELATED APPLICATIONS

The present application claims priority to U.S. Provisional Patent Application No. 62/347,016, filed on Jun. 7, 2016, the entire contents of which are hereby incorporated by reference for all purposes.

### ACKNOWLEDGMENT OF GOVERNMENT SUPPORT

This invention was made with Government support under contract no. FA8750-15-C-0245 awarded by the Air Force Research Laboratory. The Government has certain rights in the invention.

### FIELD

The disclosure pertains to computer and computer network security.

### BACKGROUND

Network and computer security has become increasingly important as businesses, individuals, and public agencies have adopted network and Internet-based tools for day to day activities. Many activities involve confidential personal information such as financial or medical records, business sensitive information or business critical systems, or information that is important for national security, defense and critical infrastructure. Such information and systems offer tempting targets to hackers, and protecting them from unauthorized access is an important concern.

Computer and network attacks related to unauthorized access to systems and information are based on a wide variety of tools and techniques such as scanning networks to find valuable assets, probing network nodes, and capturing and inspecting network traffic to find vulnerabilities. In some cases, so-called network scanning programs are used that can provide potential attackers with a road map of possible entry points. Moreover, in some cases, the goal of an attacker may be merely to swamp a network using a “denial of service attack” in which repeated requests for service are made. Many methods for defense against these and other attacks are available (e.g., cyber security systems), but they suffer from a variety of weaknesses, resulting in continued (and growing) reports of data breaches, theft of information, unauthorized access to systems, and denial of service. Weaknesses in existing systems include but are not limited to a) excess “false positives” where systems “cry wolf” falsely alerting to non-existent attacks, b) high expense in implementation, e) complicated configuration and management, c) incomplete protection, and d) high consumption of network resources.

As a result of these weaknesses, cyber security systems are often not implemented, implemented incorrectly, and/or not monitored and ignored when they generate too much information or too many false positives. Today, it is common that cyber attacks on business networks are not detected for 100 days or more, and even then, only detected when reported by third parties such as law enforcement.

The invention described in this submission relates to the field of defensive systems known as honeypots (which may be alternatively referred to as honeynets). Honeypots are computers and networks installed by organizations, seeking to provide valueless but “attractive” targets of attack for attackers. Ideally, attackers are lured into attacking the honeypot system, as opposed to a real computer or network of value. This spares the valuable assets, and the honeypots may be monitored for attacks, so that computer and network administrators may be alerted of attacks in progress.

In the past, honeypots have been classified as being either “server” or “client” honeypots. Server honeypots typically provide services on a network that respond to queries, and implement services that are similar to real server systems. This may include participating on a network and drawing from network services in the same way a real server does. Typically, server honeypots are designed to entice attackers into attacking them, as opposed to attacking real servers, thereby both sparing the real servers from attack and providing a clear indication of compromise to security administrators. Client honeypots typically are used to emulate end user devices, and automate the process of connecting to real servers in order to stimulate attack, cause upload of malware packages, and cause servers to engage in cross-site scripting or attempt to steal information from the client honeypots. Typically, these types of systems are effective in improving system security only for forms of attack that include active network scanning of server honeypots on the part of attackers, or for when client honeypots to actively attach to malicious servers. These types of solutions are typically not effective in deceiving attackers using passive network monitoring tools.

To lure attackers that use passive network monitoring tools into attacking server (or client) honeypots today, organizations would need to install real server devices and real client devices that host applications/services that the organizations would like to use to deceive hackers. Organizations would further need to populate and automate the servers and clients with fake content, and would need to automate at least the server, or client, with automation tools, to simulate real world interactivity. For example, an organization could deploy a database server on one system, a database client application on another system, populate the database with content, and create an automated script on the client application to execute end-user queries to the database server. Implementing such a system would be very expensive and time consuming, would not scale well. It would be labor intensive, and would need to be enhanced for each and every protocol an organization would like to implement. Additionally, to emulate multiple users connecting to the database server, an organization would have to deploy multiple clients, further complicating the deployment and further driving up expense.

Additionally, given that an increasing percentage of network traffic is encrypted in transit, using protocols such as Internet Protocol Security (IPSec), Transport Layer Security/Secure Sockets Layer (TLS/SSL), and Secure Real-Time Transport Protocol (SRTP), the effort and expense to create high-fidelity fake traffic using real network services and content overwhelms the returned benefits, since the final result appears as only as streams of encrypted packets. In encrypted communications, the information observable to attackers is only in the unencrypted packet headers, which include information such as source and destination Internet Protocol (IP) addresses, ports and flags. Additionally, attackers can observe packet size, frequency of transmission of packets, and delay between packet transmissions, thereby enabling them to determine that the protocols are in use, are well-formed, and are conducted between identifiable end-points—and little else.

### SUMMARY

The disclosed methods and apparatus implement simulated network communications, conducted by honeypots and honeynets, faithfully reproducing the characteristics of attacker-observable encrypted communications of real computing servers and client devices, designed to lure attackers into attacking the honeypots. The methods enable compact, reliable implementations of high fidelity, without the requirement to implement complete application suites, and without the attendant cost and complexity.

An apparatus in accordance with the present disclosure includes a honeypot server which may be implemented using any variety of techniques, running on standard OS, in embedded devices, using any computer programming language. The apparatus also includes one or more honeypot clients, where multiple honeypot clients communicate with the honeypot server, simulating typical multi-user solutions such as a real database server system providing query responses from multiple users. Alternate embodiments include client-to-client (e.g. Voice Over Internet Protocols (VoIP)), server-to-server (e.g., database replication) protocols, or any combination thereof.

The honeypot servers and honeypot clients are configured to communicate among one another using standard encrypted communications protocols such as TLS, IPSec, Media Access Control Security (MACsec), or SRTP, etc. Higher level protocols may include Hypertext Transfer Protocol Secure (HTTPS), Secure Shell (SSH), Secure File Transfer Protocol (SFTP), etc. Additionally or alternatively, the communications may use proprietary encryption protocols. Due to the encryption of the content of the communications, attackers using passive packet capture/traffic monitoring tools will at most be able to observe:
a) Packet headers/length of packets;
b) Encrypted packet contents (valueless random bits);
c) Timing and frequency of transmission; and
d) Exchange of the above between client and server honeypots, and response delay times.

To simulate network communications between client and server honeypots with a fidelity that is essentially indistinguishable from the “real” equivalent, it is therefore only necessary to send random data back and forth between client and server, with appropriate timing and packet sizes, on correct network ports. None of the complexity of the underlying protocols needs to be reproduced.

To simplify the implementation of fake network traffic, maximizing the fidelity of network communications and system reliability while minimizing network attack surface area and minimizing deployment and maintenance cost, a method in accordance with the present disclosure may include:
a) A matched set of either (i) one or more client honeypots (hereinafter referred to as a “client” or “clients”) and (ii) one or more server honeypots (hereinafter referred to as a “server” or “servers”); (i) one or more clients and (ii) one or more clients; or (i) one or more servers and (ii) one or more servers.
b) In the matched set, one or more of the honeypots run in a “remote monkey” mode, while the other honeypot(s) of the matched set run in a “master” mode. In one example, the server runs in the remote monkey mode while a client runs in the master mode. In another example, the server runs in the master mode while the client(s) run in the remote monkey mode. In yet another example, multiple clients run in a master mode (e.g., with the clients simulating web browsers) while a single server runs in the remote monkey mode (e.g., with the server emulating a web server, and with the clients and server all using HTTPS with encrypted traffic).
c) The honeypot (either server or client) running in master mode (hereinafter referred to as the “master”) executing a program of communications (based on a behavioral specification) that includes a specification of packet targets (intended recipients of or destinations for the packets sent by the master honeypot), timing, sizes, and delays designed to simulate network communications.
d) Commands originated by the master (embedded in packet payloads that are encrypted) specifying how a honeypot (either server or client) running in remote monkey mode should respond. Commands may include response specifications, e.g. packet targets (intended recipients of or destinations for the packets sent by the remote monkey honeypot), timing, sizes, and delays. Commands may also include control information such as stop/start/shutdown of the honeypot(s) running in remote monkey mode, etc.

In accordance with the above method, a matched set of honeypots simulates network protocols, the matched set including a master honeypot responsible for the initiation and orchestration of the communications and one or more remote monkey honeypots which are simply responders that follows the commands sent by the master honeypot. Only one side of the pair (e.g., the master honeypot) uses complex algorithms configured to ensure the communications are high fidelity from the attacker's perspective (e.g., to ensure that the attacker will interpret the communications as being communications between real network devices, rather than communications between honeypots). The other side behaves as a simple responder—it parses the commands embedded in the packet payload, and responds accordingly. The protocol simulation performed by the matched set of honeypots may be referred to as asymmetric protocol simulation, in view of the lack of symmetry in the computation performed by the master versus the actions performed by the remote monkey. E.g., the master controls the communications, and the remote monkey simply responds as instructed. This contrasts with other methods wherein the honeypot on each side of the communication contains instructions about the protocol, and performs independent computations about packet size, length, and delay.

In this method, the master follows a behavioral specification including instructions that specify timing and size for the originating packets. For example, the instructions include instructions regarding how long the master is to wait before sending the packet, and instructions regarding how large the packet should be. The master then generates a packet according to these specifications, which includes an unencrypted header (which includes information such as source and destination IP addresses, ports and flags, and which may be an actual IP layer 2/3 header which is used by the network itself to transmit the packets from the master to the remote monkey) and an encrypted payload.

The behavioral specification also includes a specification for the matching “response” that the remote monkey will execute. The specification for the response (referred to herein as the “response specification”) is sent as a command inside the encrypted payload of the packet sent by the master. The command inside the encrypted payload includes instructions to the remote monkey with similar properties as those specified in the behavioral specification for the originating packets (e.g., the amount of time the remote monkey should wait before replying, the size of the response packet the remote monkey sends back, and the packet target(s)). In some examples, the response specification sent to the remote monkey does not include a specification of the contents of the response to be sent by the remote monkey; instead, the remote monkey may create a response of the specified size and populate it with random bits. This may include utilizing a real encryption algorithm to generate the random bits, using fake data as input.

Because the encrypted payload is meaningless to an attacker using passive methods, the bits of the payload may be seen as “wasted” bits. This method advantageously reuses those wasted bits as the command packet. Put another way, the concept is that any information sent between the master and the remote monkey regarding the packet timing and size for the reply to be sent by the remote monkey is encrypted and cannot be seen by an attacker. For example, the information is included in the encrypted payload where “real” communications are supposed to be, along with random bits to “pad” the payload so that it has the specified size (e.g., because the response instructions may only take up a few bytes of the encrypted payload).

In accordance with this method, the master and remote monkey can communicate, emulating complex, variable bi-directional communications protocols, while benefiting from:
(a) Simple implementation that does not require complex excessive programming and synchronization between two honeypots. Only one honeypot controls the communication, and specifies the response.
(b) The ability to send commands inside “wasted” encrypted payloads, eliminating a need for external or additional control channels, reducing implementation and network complexity, and improving fidelity of the solution (e.g., as a control channel may be easily identified by an attacker and may be deemed as suspicious behavior, in effect giving away the fact that the communicating devices are honeypots). Further, embedding commands inside encrypted packets hides control information “in band” (e.g., the control data is passed on the same connection as the main data).

In accordance with the above disclosure, matched sets of honeypots can communicate to simulate any variety of encrypted protocol. To maximize the fidelity of the protocol, the time, delay, and packet sizes of the protocol should match the given protocol. For example, honeypots configured to simulate a VoIP protocol such as G.729 should select packet sizes of 20-30 bytes each. Conversely, implementations of protocols such as SFTP recommend packet sizes at a minimum of 34,000 bytes (though Internet traffic is typically reduced in size to 1500 or 576 bytes). For protocols such as VoIP, packets will be sent frequently for the duration of audio transmission (Real-Time Transport Protocol (RTP) silence suppression notwithstanding). For example, the frequency at which the packets will be sent for VoIP G.729 is 50 packets per second. Conversely, protocols such as SFTP or Hypertext Transfer Protocol (HTTP) for web browsing are very “bursty” and intermittent (e.g. HTTP web browsing packets may only be sent as a user loads/changes a web page or clicks on a web page link)

To ensure creation of a program that specifies packet timing, size, and delay with which honeypots communicate with high fidelity, several methods are available, such as:
a) Manual construction of the program, wherein each packet exchange is manually specified through the review of protocol standards documents. This approach may be tedious and time consuming, and may not match the characteristics of the protocols in use in the real world. This approach also does not work well for undocumented protocols.
b) Simple recording of protocols used in communications between real network devices using packet capture or traffic monitoring tools, followed by playback. This method scales well and improves fidelity (e.g., results in a playback of protocols which closely resembles real traffic as opposed to methods relying on fixed scripts such as those developed manually which are described in (a) above, particularly if the recording is done on the networks on which the playback will be implemented). However, this approach suffers from a lack of variety; e.g., patterns may be observable, tipping off attackers that the communications are artificial.
c) Analysis of recorded protocols, and implementation of statistical (or other) models that introduce variability into the execution of the protocols, providing a much better approximation of real-world protocols over time.

The methods described herein can use any of the protocol program implementations above, and further include a novel use of a stochastic model known as a discrete-time Markov chain to closely approximate the variations present in real-world use of communications protocols. This includes the recording of network protocols (e.g., network protocols for communications between real network devices), the statistical analysis of the timing, packet sizes, and delay features of the protocols, and the playback of protocols using the Markov chain to guide the probabilistic selection of a packet's properties based on the preceding packet's properties. Discrete-time Markov chains are described in detail in “S. Russell & Norvig: Artificial Intelligence; A Modern Approach, Prentice Hall, 1995”.

Using these methods, behavioral specifications with high fidelity may be developed using automated means, rather than manual means. Accordingly, only limited subject matter expertise may be required to develop the programs, and yet the programs may contain variability consistent with real-world use of the simulated protocol.

The foregoing and other objects, features, and advantages of the invention will become more apparent from the following detailed description, which proceeds with reference to the accompanying figures.

### BRIEF DESCRIPTION OF THE DRAWINGS

FIG. 1A is a block diagram illustrating a network configuration of one honeypot server and multiple honeypot clients, communicating over a network. The diagram further illustrates an attacker observing the communications via a network tap.

FIG. 1B is a block diagram illustrating a network configuration of one real (non-honeypot) server and multiple real (non-honeypot) clients, communicating over a network. The diagram further illustrates a developer of a behavioral specification observing the communications via a network tap.

FIG. 2 is a block diagram illustrating a computing device including exemplary honeypots and the components thereof.

FIG. 3 is a block diagram illustrating a honeypot client acting as master, reading instructions in the behavioral specification and initiating communications to a honeypot server acting as remote monkey, which responds as instructed.

FIG. 4 is a flow chart illustrating a control method for a master module in a honeypot.

FIG. 5 is a flow chart illustrating a control method for a remote monkey module in a honeypot.

FIG. 6 is a flow chart illustrating a method for generating and using Markov chains to control the generation of simulated protocol packets.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items. However, the term “directly coupled” does exclude the presence of intermediate elements between the directly coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

Disclosed herein are methods and apparatus to deceive and entice network attacker to attack honeypot systems, rather than real systems. The apparatus and methods enable organizations looking to protect their systems to do so in a cost-effective manner, and further enable organizations to deceive attackers using passive network methods.

Some aspects of methods and systems that can address some or all of these goals are set forth below.

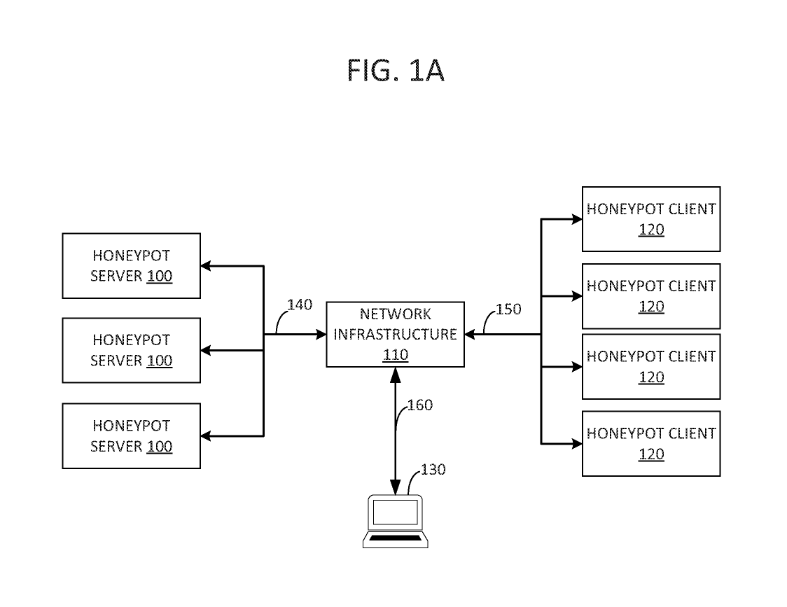

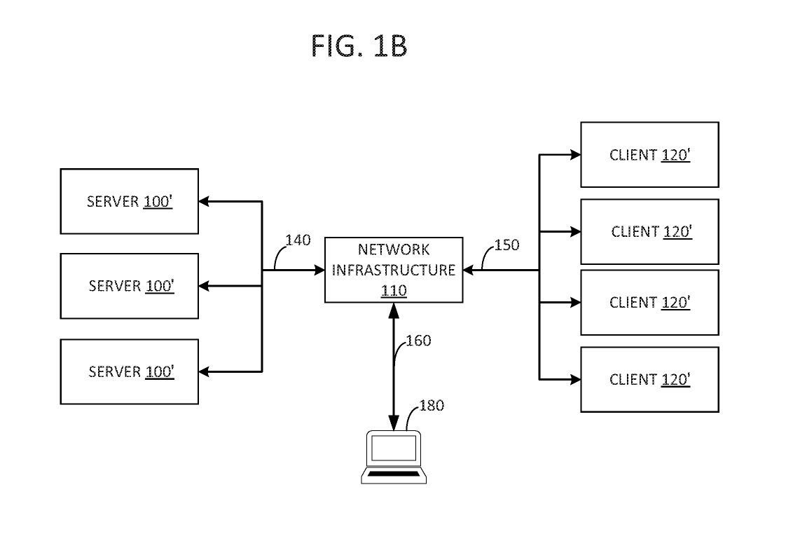

FIG. 1A illustrates a network diagram where one or more attackers 130 have gained access to a network infrastructure 110, e.g. via one or more network taps 160, and are therefore able to observe network traffic patterns using tools such as network flow analyzers, protocol analyzers, or packet capture tools. As used herein, the term “attacker” refers to an unauthorized user of the system, or someone that is using access in a way that it was not intended to be used. Network taps 160 may comprise any number of means for acquiring network packets, including configuring switches/routers to mirror traffic to the attacker, inserting a network hub into an Ethernet network, or through capture of electro-magnetic emissions along a network cable. Network infrastructure 110 may include networking hardware, networking software, and network services, for example. References to a “network” herein may be interpreted as referring to network infrastructure 110. With access to a network infrastructure, attackers are able to observe communications between any two (or more) network devices. In the age of encrypted traffic, however, attackers are frequently limited to observing just control traffic and packet headers/sizing, but are not able to see inside packet payloads.

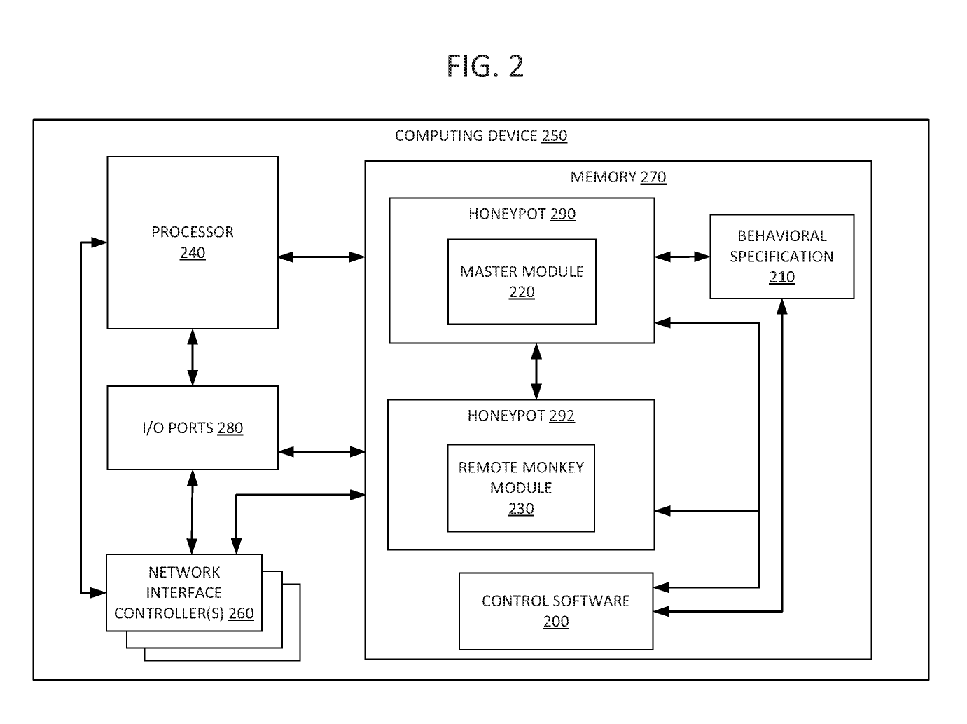

The embodiment shown in FIG. 1A includes the implementation of encrypted communications between honeypots, each honeypot acting as a honeypot server 100 or honeypot client 120, between which artificial communications are conducted over channels 140 and 150 of the compromised network. For example, as shown, fake communications among honeypot clients and fake communications between honeypot clients 120 and network infrastructure 110 may be conducted over channel 150, and fake communications among honeypot servers 100 and fake communications between honeypot servers 100 and network infrastructure 110 may be conducted over channel 140. Channels 140 and 150 may be in-band channels. In this embodiment, artificial communications may be intercepted between honeypot servers and clients, between two honeypot clients, and/or between two honeypot servers. Each honeypot client 120 and each honeypot server 100 is hosted on and deployed by a computing device, as shown in FIG. 2.

FIG. 1B illustrates a network diagram where one or more developers of behavioral specifications 180 have gained access to a network infrastructure 110, e.g. via one or more network taps 160, and are therefore able to observe network traffic patterns using tools such as network flow analyzers, protocol analyzers, or packet capture tools. Like-numbered elements of FIG. 1B correspond to the elements of FIG. 1A.

In contrast to the network shown in FIG. 1A, in the network shown in FIG. 1B, communication takes place between real network devices, rather than honeypots. The exemplary real network devices shown in FIG. 1B include one or more servers 100′ and one or more clients 120′. Real communications among the servers and clients are conducted over channels 140 and 150 of the network. For example, as shown, communications among clients 120′ as well as communications between clients 120′ and network infrastructure 110 may be conducted over channel 150, and communications among servers 100′ as well as communications between honeypot servers 100′ and network infrastructure 110 may be conducted over channel 140. As in the network of FIG. 1A, channels 140 and 150 may be in-band channels. In this embodiment, the real communications may be intercepted between servers and clients, between two clients, and/or between two servers.

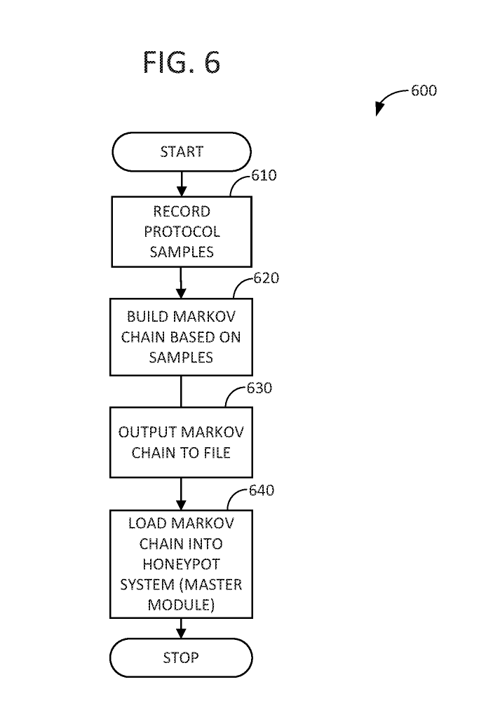

The developer(s) of behavioral specifications 180 intercept and record the real communications via network tap(s) 160. The recorded real communications are then stored in non-transitory memory and used to generate a Markov chain, which in turn may be used in the creation of fake communications to be sent among honeypots (as detailed below with reference to FIG. 6). Developer(s) of behavioral specifications 180 may include computing devices external to the network and the users thereof, in which case the recorded real communications may be stored in non-transitory memory of one or more computing devices external to the network. In other examples, however, the developer(s) of behavioral specifications 180 may include computing devices that are part of the network and the users thereof, in which case the recorded real communications may be stored in non-transitory memory of one or more computing devices that are part of the network.

In some examples, the real network devices and honeypots may be part of, and communicate over, a common “hybrid” network, which includes real devices as well as fake devices. In other examples, the real network devices may be part of a training network, used for development purposes, whereas the honeypots may be part of a fake network distinct from the training network, where the entire fake network is made up of fake devices.

FIG. 2 illustrates a block diagram of an exemplary computing device 250 which serves as a host for one or more honeypots, such as the illustrated exemplary honeypots 290 and 292. In the depicted example, computing device 250 includes a processor 240; one or more network interface controllers 260 enabling communication over a network; memory 270 storing honeypots 290 and 292 and a behavioral specification 210; input/output (I/O) ports 280; and control software 200. Non-limiting embodiments of computing device 250 may include embedded devices, standalone devices, network appliances, clustered devices, compute-as-a-service, or cloud infrastructure. In other examples, virtualized or containerized hosts are also deployment options for the honeypots. The hardware and system services for computing device 250 are typically provided by any variety of operating system (e.g., Windows, Linux, Real-Time Operating System (RTOS), Library Operating System (OS), etc.).

Memory 270 of computing device 250 comprises non-volatile memory which stores data such as instructions executable by a processor (e.g., processor 240 or network interface controller 260) in non-volatile form. Memory 270 may further comprise volatile memory, such as random access memory (RAM). Non-transitory storage devices, such as non-volatile and/or volatile memory of memory 270, may store instructions and/or code that, when executed by a processor, control the computing device to perform one or more of the actions described in this disclosure.

Control software 200 may be a piece of computer software responsible for administrative functions. In the depicted example, control software 200 is stored in memory 270 of computing device 250. In other examples, control software 200 may reside in the cloud or may be stored and executed in a separate hardware device in communication with computing device 250.

Each network interface controller (alternatively referred to as network interface card or NIC) 260 may be operatively coupled to honeypots 290 and 292, thereby providing network connectivity. Computing device 250 may include a single NIC, a first NIC and a second NIC, or any other appropriate number of NICs (e.g., one NIC per honeypot, or one NIC serving multiple honeypots). NICs 260 may be wired or wireless, and/or may include any physical medium capable of transmitting data including IP communications.

One of honeypots 290 and 292 is a server honeypot, while the other of honeypots 290 and 292 is client honeypot. For example, if honeypot 290 is a server, honeypot 292 is a client, whereas if honeypot 290 is a client, honeypot 292 is a server. While the example shown in FIG. 2 illustrates only two honeypots, it will be appreciated that in other examples, more than two honeypots may be included in memory 270 of computing device 250. For example, memory 270 may include three, four, five, or more client honeypots and one server honeypot. In the depicted example, honeypot 290 serves as the master and thus includes a master module 220. Master module 220 includes instructions which are executable by a processor to initiate and control artificial communications in accordance with instructions included in behavioral specification 210. In contrast, in the depicted example, honeypot 292 serves as a remote monkey and thus includes a remote monkey module 230 including instructions which are executable by a processor to simply respond to “reply” instructions received in embedded, encrypted packet payloads (e.g., from the master module). In contrast to honeypot 290, honeypot 292 does not directly read the behavioral specification 210 or communicate using the behavioral specification 210.

It will be appreciated that honeypots 290 and 292 may include a wide variety of services/modules in addition to the functions described herein. Further, control software 200 which is stored in memory 270 (or stored/hosted elsewhere in other embodiments) may be responsible for administrative functions (e.g., start/stop, etc.) of the honeypots.

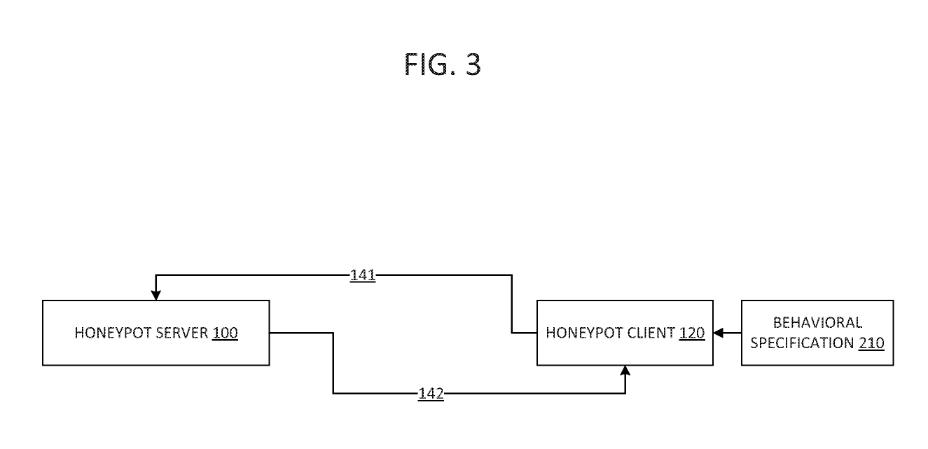

FIG. 3 illustrates an exemplary communications session between a honeypot client 120 acting as a master, and a honeypot server 100 acting as a remote monkey. In this example, honeypot client 120 reads instructions included in behavioral specification 210, and follows the instructions accordingly. The behavioral specification can include a wide variety of instruction formats including but not limited to:
a) A simple linear program defining packets to be sent and received. The program can include the initial delay, the packet size to be sent, and the specification of delay and packet size to be encrypted in the sent payload, thus forming the instructions for the remote monkey to use in creating the reply packet.
b) A more complex program enabling more variability in behavior relative to the linear program, such as parameterized values in the program above, where the sender and receiver may select from a range of values (e.g., values for initial delay and packet size).
c) A Markov chain, which describes a state-space that is randomly traversed based on probabilities trained from samples of protocols. The master navigates the state-space, reproducing a sequence of events (packets sent), that optimally simulates the protocol. The Markov chain specifies initial delay, packet sizes to be sent, and as well as reply delays and packet sizes.

The honeypot client (serving as master) 120 reads the behavioral specification 210, constructs the packet to send, and sends it to the honeypot server (acting as remote monkey) 100 over a channel 141. Channel 141 may be an in-band channel in one example, and is intended to be intercepted by an attacker. The honeypot server 100 waits the specified amount of time (e.g., the time specified by the initial delay parameter), and then sends a reply packet back to the honeypot client 120 over a channel 142, which is free to ignore the packet, or to accept it and process it as if it were an ACK (acknowledgement packet) indicating to the master that the remote monkey (server) is responding correctly. Channel 142 may also be an in-band channel, in one example, and is a channel intended to be intercepted by an attacker.

In more complex embodiments, chaining (forwarding) of communications may be implemented by embedding one or more subsequent IP addresses in the encrypted packet (payload). Inside the encrypted payload, each honeypot operating as a remote monkey may receive one or more IP addresses in addition to delays and packet sizes. Each received IP address can identify a new destination for the packet that the remote monkey sends (instead of the remote monkey just replying to the master). The remote monkey may remove the one or more IP addresses from the encrypted payload, and then forward the packet onwards to the one or more IP addresses. This embodiment enables a solution to simulate full network architectures, including simulating proxies, Network Address Translation (NAT) devices, or meshed networks.

The packets sent by honeypots acting as master are typically larger than is needed simply to include the instructions. For example, if the payloads of the packets include instructions that consist of 2 bytes each for delay and packet size, and the artificial communications protocol being simulated is G.729 VoIP with a voice payload size of 20 bytes, then 16 bytes of the payload (20 bytes total including 4 bytes for instructions) are wasted space. To ensure that the cipher text stream does not include repeating patterns that may reduce the fidelity of the encryption, the wasted space may be filled with random data, serving a salt-like function.

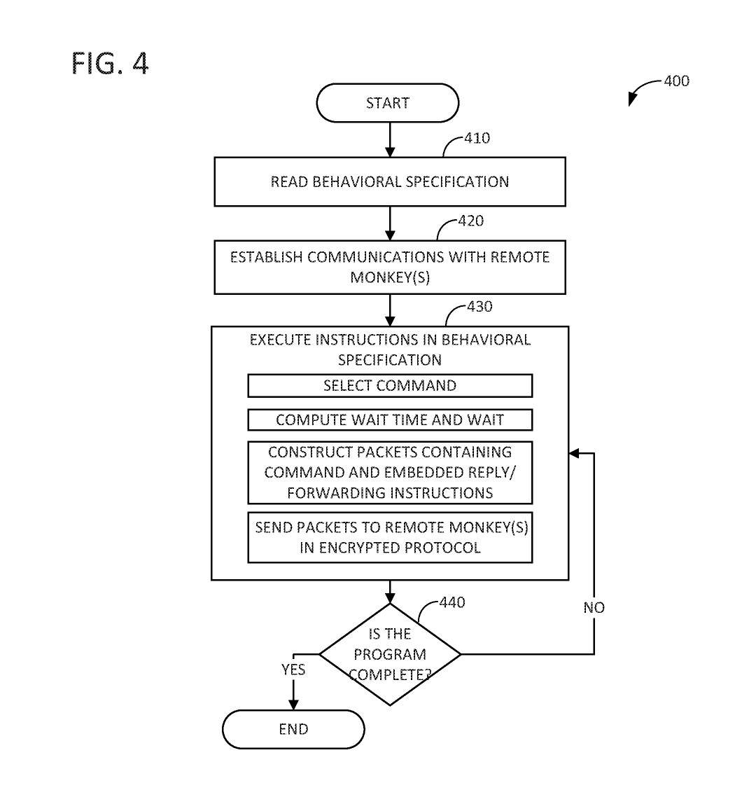

FIG. 4 illustrates a flow diagram of a method 400 in which a honeypot (either server or client) acts as a master. In one example, method 400 may be performed by honeypot 290 of FIG. 2. Instructions executable to perform method 400 may be stored in memory of a computing device in a master module of the honeypot, such as master module 220 of FIG. 2, and may be executed by a processor such as processor 240 of FIG. 2, for example.

On startup (e.g., at the start of execution of the instructions stored in the master module), method 400 proceeds to 410. At 410, the honeypot reads a behavioral specification (e.g., behavioral specification 210 of FIG. 2). After 410, the method proceeds to 420 and the honeypot acting as a master establishes communication with one or more honeypots acting as remote monkeys. After 420, the method proceeds to 430 and the master executes the instructions in the behavioral specification. Executing the instructions in the behavioral specification may include selecting a command. The method used by the master to select which command to send depends upon the implementation of the behavioral specification and the algorithm used to execute the behavioral specification. In the event the behavioral specification is a manually generated or linear set of instructions, commands are executed in series. In one embodiment, using a Markov chain as the behavioral specification, the command is selected based on the current system state and a statistically generated model that reflects the probabilities of the occurrence of a specific command (packet) in the training dataset, given the current state. For example, given a state (either an initial state, or the state as defined by the last command sent), the Markov chain specifies the ratio of occurrence of a command, within a set of commands. Executing commands based on the Markov chain involves randomly selecting a command, based on the existing state and the probabilities of the occurrence of a specific command, such that the selection of a specific command from a set of commands occurs randomly, but with a frequency that matches the probabilities in the Markov chain.

In some examples, the initial state may be specified in the behavioral specification based on initial commands (packets) occurring in the set of training data, which may include recordings of multiple sessions. For example, the behavioral specification may include a number of possible initial packets to select from, and the selected initial packet, after being sent, subsequently serves as the preceding packet when the next packet is sent. As used herein, the preceding packet may refer to the last packet that was sent, e.g., the packet sent most recently.

As shown at 430, executing the instructions in the behavioral specification may further include computing (if necessary) a wait time (e.g., initial delay) value, waiting the corresponding amount of time, then constructing and sending packets of the correct (specified) size, the packets including the selected command along with embedded reply and/or forwarding instructions, to one or more remote monkeys. As indicated, the packets may be sent in an encrypted protocol.

If the behavioral specification has a logical termination (as is the case with a linear behavioral specification), the master continues to advance through the behavioral specification until it reaches the end of the program. At 440, upon reaching the end of the program, the master terminates communications with the remote monkey(s). Alternatively, for looping behavioral specifications, the master continues executing the program until it is terminated via external means. After 440, method 400 ends.

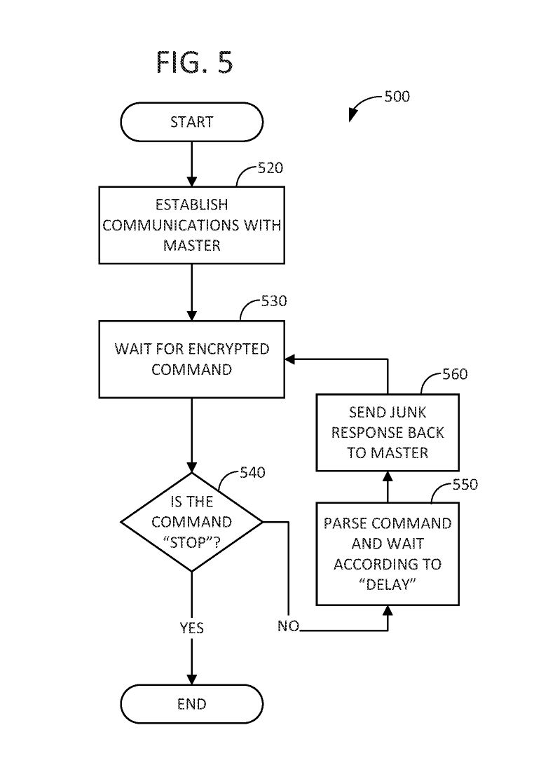

FIG. 5 illustrates a flow diagram of method 500 in which a honeypot (either server or client) acts as a remote monkey. In one example, method 500 may be performed by honeypot 292 of FIG. 2. Instructions executable to perform method 500 may be stored in memory of a computing device in a remote monkey module of the honeypot, such as remote monkey module 230 of FIG. 2, and may be executed by a processor such as processor 240 of FIG. 2, for example.

On startup, the method proceeds to 520 and the honeypot establishes communications with one or more honeypots acting as master honeypots. At 530, the remote monkey then waits for any commands received from the master honeypot(s). Upon receipt of a command, the method proceeds to 540 and determines whether the command is a “stop” command. Upon receipt of a “stop” command, the communications terminate and the method ends. Otherwise, if the command received is not a “stop” command, the method proceeds from 540 to 550 and the remote monkey honeypot parses and executes the command and waits the instructed period of time (e.g., the delay time indicated in the command received from the master). After the remote monkey waits for the instructed period of time, the method proceeds to 560, and the remote monkey constructs and sends a reply in accordance with the command received from the master. After 560, the method returns to 530 and waits for further encrypted commands.

FIG. 6 illustrates a flow diagram of a method 600 for the generation and incorporation of a Markov chain into a system of honeypots. Instructions executable to perform method 500 may be stored in memory of a computing device, such as memory 270 of FIG. 2, and may be executed by a processor such as processor 240 of FIG. 2, for example.

At startup, the method proceeds to 610, which includes recording sample communication protocols, which are subsequently used to create a Markov chain. In one example, this recording can be accomplished by one or more developers of behavioral specifications (e.g., developer(s) of behavioral specification 180 shown in FIG. 1B) using protocol capture or analysis tools against single protocols or multiple protocols simultaneously. The method of capture includes the interception of protocols between one or more real networked devices, and thus the methods of capture are not unlike the methods used by attackers (e.g., attacker 130 shown in FIG. 1A). Additionally, packet capture and protocol analyzer tools may be placed directly on the client or server computing platforms intercepting packets on those devices, since those platforms are under the control of the person conducting the development of the behavioral specification

After 610, method 600 proceeds to 620, which includes generating a Markov chain by statistically analyzing the recorded protocols. Other embodiments include manually generating behavioral specifications using the Markov chain format, e.g. where protocol capture is not available. In such instances, the data format for the model may be populated manually with best estimates of packet sizes, delays, and probabilities of each packet size/delay occurring given a system state. The resulting program can still exhibit a great deal of randomness and variability. Using this method, a master module and a remote monkey module may use a single, common data format for sample-learned Markov chains and for manually-generated chains.

After 620, the method proceeds to 630, which includes outputting and saving the Markov chain to a file (in any reasonable format such as Extensible Markup Language (XML), binary, etc.) stored in memory. After 630, the method proceeds to 640 and incorporates the saved Markov chain into the system of honeypots. Incorporating the saved Markov chain into the system of honeypots may involve simply loading the file including the Markov chain onto the honeypot system via standard file transfer mechanisms such as FTP, or through the use of removable media. After 640, method 600 ends.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the network configuration shown in FIGS. 1A-1B and the components thereof. The methods may be performed by executing stored instructions with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. A method for emulating devices communicating over one or more networks, the one or more networks comprising a plurality of real network devices and a plurality of honeypots emulating real network devices, the honeypots stored on one or more of the real network devices, the method comprising instructions executable by a processor to:
intercept and record protocols used in communications between real network devices;
statistically analyze the recorded protocols; and
develop a behavioral specification for at least one master honeypot, the behavioral specification including instructions executable by a processor to construct packets having properties determined via the statistical analysis, each packet including an unencrypted header and an encrypted payload, each encrypted payload comprising a response specification to be executed by at least one remote monkey honeypot, the behavioral specification further including instructions to send the packets from the at least one master honeypot to the at least one remote monkey honeypot.

2. The method of claim 1, wherein recording the protocols comprises recording properties of packets communicated between the real network devices, the properties of the packets communicated between the real network devices including one or more of a frequency of packet transmission, wait times before sending packets, and packet sizes.

3. The method of claim 2, wherein developing a behavioral specification based on the statistical analysis comprises generating a Markov chain based on the statistical analysis, and generating instructions executable by a processor to send an initial packet from the at least one master honeypot to the at least one remote monkey honeypot and then send one or more further packets from the at least one master honeypot to the at least one remote monkey honeypot, and wherein the behavioral specification includes instructions executable by a processor to use the Markov chain to guide the probabilistic selection of properties of each of the one or more further packets to be sent by the at least one master honeypot to the at least one remote monkey honeypot based on properties of a preceding packet sent by the at least one master honeypot to the at least one remote monkey honeypot.

4. The method of claim 1, wherein the instructions to construct the packets comprise instructions specifying one or more of a frequency of packet transmission, a wait time before sending a packet, and a packet size, and instructions specifying properties for response packets to be sent by the at least one remote monkey honeypot, wherein the properties for the response packets include a wait time and a packet size and are included in the response specification.

5. The method of claim 4, wherein the behavioral specification further comprises instructions executable by a processor to, upon receipt of a packet at the at least one remote monkey honeypot from the at least one master honeypot, wait for the wait time specified in the response specification, construct a response packet having the properties specified in the response specification, and send the response packet to a packet target.

6. The method of claim 5, wherein the packet target is the at least one master honeypot and/or at least one other remote monkey honeypot.

7. The method of claim 1, wherein each master honeypot is either a honeypot emulating a network client or a honeypot emulating a network server, and wherein each remote monkey honeypot is either a honeypot emulating a network client or a honeypot emulating a network server.

8. The method of claim 4, wherein each payload further includes a packet target, and wherein each packet target includes one or more IP addresses, the one or more IP addresses identifying a new destination to which the packet including the payload is to be sent by the at least one remote monkey honeypot.

9. The method of claim 8, wherein the behavioral specification further comprises instructions executable by a processor to, upon receipt of a packet including a payload with a packet target at the remote monkey honeypot, remove the one or more IP addresses from the payload and then forward the packet to the one or more IP addresses.

10. A method for emulating devices communicating over a network, the network comprising a plurality of real network devices and a plurality of honeypots emulating real network devices, the honeypots stored on one or more of the real network devices, the method comprising:
recording properties of packets communicated between the real network devices;
statistically analyzing the properties of the packets;
generating a Markov chain based on the statistical analysis; and
generating packets at a master honeypot to be sent to a remote honeypot by using the Markov chain to guide the probabilistic selection of properties of the packets, each packet comprising an unencrypted header and an encrypted payload, the payload comprising a response specification to be executed by the remote monkey honeypot.

11. The method of claim 10, wherein the remote monkey honeypot does not include instructions to generate packets.

12. The method of claim 10, wherein the Markov chain is included in a behavioral specification stored and executed at the master honeypot, and wherein the behavioral specification is neither stored nor executed at the remote monkey honeypot.

13. A system, comprising:
a plurality of real computing devices including one or more server devices and one or more client devices,
a plurality of honeypots emulating real computing devices, including one or more honeypots emulating server devices and one or more honeypots emulating client devices, each honeypot acting as either a master or a remote monkey, and each honeypot stored in non-transitory memory of one of the real computing devices; and
instructions stored in non-transitory memory of one of the real computing devices and executable by a processor of one of the real computing devices to:
generate a behavioral specification having a Markov chain format for a master honeypot; and
at the master honeypot, use the behavioral specification to guide the probabilistic selection of properties of a packet to be sent by the at least one master honeypot based on properties of a preceding packet sent by the master honeypot, and send the packet to at least one remote monkey honeypot.

14. The system of claim 13, further comprising a computing device comprising protocol monitoring, capture and/or analysis tools, and instructions stored in non-transitory memory of one of the real computing devices and executable by a processor of one of the real computing devices to:
record properties of packets sent between the real computing devices using the protocol capture and analysis tools;
statistically analyze the recorded properties of the packets; and
generate the behavioral specification having the Markov chain format based on the statistical analysis.

15. The system of claim 13, further comprising instructions stored in non-transitory memory of one of the real computing devices and executable by a processor of one of the real computing devices to:
manually generate the behavioral specifications, using the Markov chain format, based on estimates of packet sizes, delays, and probabilities occurring during a given system state.

16. The system of claim 13, wherein each packet sent by the at least one master honeypot comprises an unencrypted header and an encrypted payload, the payload comprising a response specification to be executed by the at least one remote monkey honeypot.

17. The system of claim 16, wherein the behavioral specification comprises instructions specifying one or more of a frequency of packet transmission, a wait time before sending a packet, and a packet size, and wherein each payload includes a response specification, the response specification a wait time, a packet size for a response packet to be sent by the at least one remote monkey honeypot, and a packet target.

18. The system of claim 17, further comprising instructions stored in non-transitory memory of one of the real computing devices and executable by a processor of one of the real computing devices to:
upon receipt of the packet from the master honeypot by the at least one remote monkey honeypot, waiting for the wait time, constructing the response packet in accordance with the response specification, and sending the response packet to the packet target.

19. The system of claim 13, wherein each honeypot is either a honeypot emulating a network client or a honeypot emulating a network server.

20. The system of claim 13, wherein the remote monkey honeypots are not configured to execute behavioral specifications.
